(19) United States
(12) Patent Application Publication
(10) Pub. No.: US 2001/0024966 A1
(43) Pub. Date: Sep. 27, 2001

(54) Communications system

(76) Inventors: Norbert Miller, Monchengladbach (DE); Markus Schneider, Alsdorf (DE)

Correspondence Address: CANTOR COLBURN, LLP, 55 GRIFFIN ROAD SOUTH, BLOOMFIELD, CT, 06002

(21) Appl. No.: 09/768,992

(22) Filed: Jan. 24, 2001

(30) Foreign Application Priority Data
Jan. 24, 2000 (EP) 00101353.1

(51) Int. Cl. H04M 1/00

(52) U.S. Cl. 455/569; 455/557; 455/41; 379/56.3

(57) ABSTRACT

The invention proposes a communications system that includes at least one stationary transmitting/receiving unit connected to a communications terminal, a mobile radio terminal and a transmitting/receiving unit connected to the microphone and the loudspeaker of the mobile radio terminal that can be connected wirelessly to the stationary transmitting/receiving unit.

This invention concerns a communications system.

In many applications, communications systems are known in which so-called intercom systems are used. These are microphone/loudspeaker combinations positioned at various places that are connected to communications terminals, for example central offices in parking garages and surveillance systems in elevator systems, access-authorization systems and the like.

In many cases, it is impractical or there is a cost involved for potential users of intercom systems to move in the area near the intercom system, to activate it and most often to communicate with their partner for information or assistance purposes.

The object of this invention is to improve a communications system of the type described to make it much simpler for potential users to use.

For accomplishing the object, the invention proposes a communications system that includes at least one stationary transmitting/receiving unit connected to a communications terminal, a mobile radio terminal and a transmitting/receiving unit, that is connected to the microphone and the loudspeaker of the mobile radio terminal, that is wireless and that can communicate with the stationary transmitting/receiving unit.

According to the invention, the user has a mobile radio terminal, a so-called handy, whose microphone and loudspeaker unit are connected to another transmitting/receiving unit via their internal electronics. Such units are known as so-called “Blue Tooth.” The invention provides that a stationary transmitting/receiving unit be arranged in the corresponding area that is in turn connected to the communications terminal. The user can now activate this transmitting/receiving unit by using the transmitting/receiving unit in the area of his handy.

For example, a person who is in their car in a garage, can use an intercom system easily by using the user transmitting/receiving unit. Listening and speaking then take place using this additional unit via the handy. This is not a mobile radio connection in the sense of the existing mobile radio networks, but a separate additional transmitting/receiving unit. The intercom system can be activated in various ways, for example by dialing a code or the like.

According to the invention, the non-stationary transmitting/receiving unit is built into the handy. The invention proposes that this mobile unit be able to be connected separately so that each stationary transmitting/receiving unit automatically connects with the mobile unit, not vice versa.

According to the invention, communication can be initiated in various ways. Thus, communication can be initiated by the mobile transmitting/receiving unit by having a signal sent to the stationary unit by it automatically or at the operator's choice, and communication is produced. Alternately, the stationary transmitting/receiving unit can send out signals so that mobile units coming into communication range automatically enter into communication. Initiation can take place automatically when use starts.

Insofar as, according to the invention, the stationary transmitting/receiving unit is coupled directly to an intercom system, the invention also proposes that both stationary systems be used in parallel operation permanently. Alternately, only one of the two can be used, depending on the activation process.

Besides its use in parking garages, there are also applications in elevators, access-authorization systems, house door systems, gasoline pump systems, safety systems, in the area of passenger traffic and the like.

Advantageously, the transmitting/receiving units are capable of digital data transfer. That way, not only can conversations be carried on, but information can also be transmitted digitally.

Another advantageous proposal in the invention is that the connection be an optical one. Thus, for example, an infrared interface capable of transmitting/receiving in the handy can be used for communication with a corresponding interface on the stationary unit.

Other advantages and features of the invention will emerge from the following description using the figures.

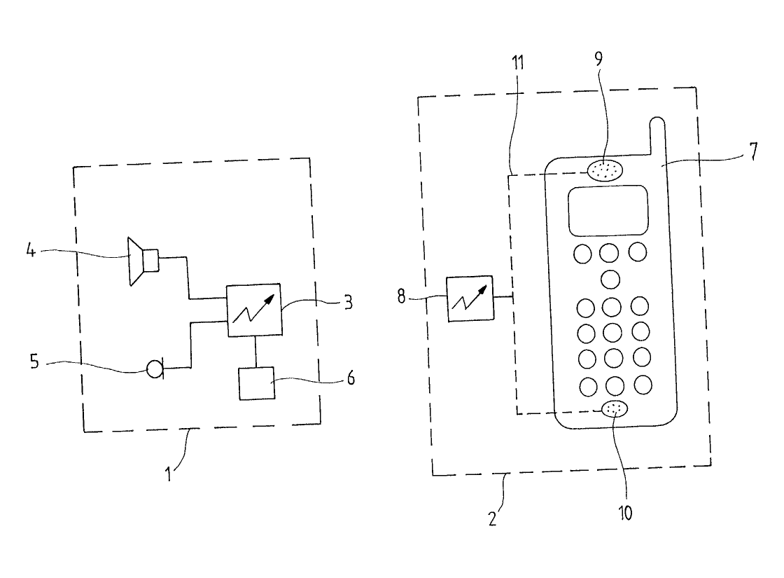

FIG. 1 shows a schematic view of one example of embodiment of the invention.

FIG. 1 is a schematic view of an area 1 of a stationary transmitting/receiving system and an area 2 of a mobile transmitting/receiving system.

In the area near the stationary transmitting/receiving system 1, a transmitting/receiving unit 3 is arranged that is connected to at least one loudspeaker 4 and one microphone 5. It can be a cable connection in a user console or a radio connection. Several loudspeaker/microphone units can also be connected. It also shows controls 6, which can activate the transmitting/receiving unit 3.

In the area near the mobile transmitting/receiving unit 2, indicated for example by a handy 7, which has a loudspeaker 9 and a microphone 10 as well as an additional transmitting/receiving unit 8, the latter can also be coupled to the mobile radio unit with the loudspeaker 9 and the microphone, indicated by dashes 11.

Now both units can be connected via the stationary transmitting/receiving unit 3 and the mobile transmitting/receiving unit 8, whereby the mobile unit 8 uses the microphone 10 and the loudspeaker 9 of the handy 7.

The example of embodiment described is only for clarification and is not limiting.

1. A communications system, comprising:
at least one stationary transmitting/receiving unit connected to a communications terminal;
a mobile radio terminal; and
a transmitting/receiving unit connected to a microphone and a loudspeaker of the mobile radio terminal that can communicate with the stationary transmitting/receiving unit.

2. The communications system in claim 1, characterized in that both transmitting/receiving units can be connected over a near radio range.

3. The communications system in one of the preceding claims, characterized in that the non-stationary transmitting/receiving unit is integrated into the mobile radio terminal.

4. The communications system in one of the preceding claims, characterized in that communication is initiated by the non-stationary transmitting/receiving unit.

5. The communications system in one of the preceding claims, characterized in that the non-stationary transmitting/receiving unit is coupled to an intercom system.

6. The communications system in claim 5, characterized in that the stationary transmitting/receiving unit and the intercom are operated permanently in parallel.

7. The communications system in one of the preceding claims, characterized in that it can be used in a parking garage.

8. The communications system in one of claims 1 to 6, characterized in that it can be used in an access-authorization system.

9. The communications system in one of the preceding claims, characterized in that the connection between the transmitting/receiving unit is suitable for digital data transfer.

10. The communications system in one of the preceding claims, characterized in that the connection between the transmitting/receiving unit is an optical connection.
